(19) United States
(12) Patent Application Publication
(10) Pub. No.: US 2026/0208725 A1
(43) Pub. Date: Jul. 23, 2026

(54) AUTOMATIC MANEUVERING OF A VEHICLE ON THE BASIS OF A CLEARANCE PROCESS

(71) Applicant: Valeo Schalter und Sensoren GmbH, Bietigheim-Bissingen (DE)

(72) Inventor: Luc Jansseune, Creteil (FR)

(73) Assignee: Valeo Schalter und Sensoren GmbH, Bietigheim-Bissingen (DE)

(21) Appl. No.: 19/141,762

(22) PCT Filed: Dec. 12, 2023
(86) PCT No.: PCT/EP2023/085288

§ 371 Date: Jun. 20, 2025

(30) Foreign Application Priority Data
Dec. 21, 2022 (DE) 10 2022 134 369.3

(51) Int. Cl. B60W 30/06; G06T 7/579; G06V 10/60; G06V 10/75; G06V 20/58

(52) U.S. Cl. CPC B60W 30/06; G06T 7/579; G06V 10/60; G06V 10/751; G06V 20/58; B60W 2420/403; B60W 2420/408; B60W 2556/10; B60W 2556/50; G06T 2207/30252

(57) ABSTRACT

Described is a method for ascertaining a stepwise clearance for a vehicle to automatically maneuver the vehicle along a specified driving route from a current vehicle position to a destination. The vehicle has a sensor system with an optical camera for monitoring the surroundings in the driving direction of the vehicle. The method includes providing a current video image of the optical camera at the current vehicle position, ascertaining the clearance to automatically maneuver the vehicle along the specified driving route on the basis of an automatic comparison of image information from a monitored region of the video image with reference image information from the monitored region on the basis of a previously captured comparison image, and outputting the ascertained clearance to automatically maneuver the vehicle along the specified driving route in a step which corresponds to the current video image.

The present invention relates to a method for determining step-by-step clearances for a vehicle for automatic maneuvering along a predetermined driving route from a current vehicle position to a destination point, wherein the vehicle comprises a sensor system having at least one optical camera for monitoring the surroundings in the direction of travel of the vehicle.

Furthermore, the present invention relates to a method for clearance-based automatic maneuvering of a vehicle along a predetermined driving route from a current vehicle position to a destination point, wherein the vehicle comprises a sensor system having at least one optical camera for monitoring the surroundings in the direction of travel of the vehicle, wherein the method comprises determining step-by-step clearances for automatic maneuvering of the vehicle along the predetermined driving route using the above method.

The present invention also relates to a driver assistance system for a vehicle, wherein the driver assistance system is designed to carry out the above method.

The present invention also relates to a cloud-based driver assistance system having at least one vehicle and a cloud-based clearance server, wherein the at least one vehicle and the cloud-based clearance server are connected to one another via a data connection, and the cloud-based driver assistance system is designed to carry out the above method.

Various types of assistance systems are already used in current vehicles in order to make driving with the vehicle safer and more relaxing. These include emergency braking systems, lane keeping systems, distance control systems, or also cross traffic warning systems, to mention only a few. Such assistance systems are partially subsumed under the term ADAS (Advanced Driver Assistance Systems).

In addition, applications in the area of “autonomous driving” are continuously being refined to relieve the driver of the vehicle ever more, up to a driving operation in which the vehicle drives completely autonomously and a vehicle driver in the conventional sense is no longer required. The longer-term goal is to achieve autonomous driving in the sense of SAE standard J3016 at level 5, wherein level 5 relates to autonomous driving without intervention by a vehicle driver. Currently, first systems of level 4 for specific applications are being brought to market readiness.

For all of these applications, it is important to detect the surroundings of the vehicle as reliably as possible. This relates to both static and dynamic objects. In particular, the detection of dynamic objects is typically based on a detection of the surroundings by the vehicle itself using a corresponding sensor system. It is to be taken into consideration here that any type of surroundings sensors used, such as optical cameras, LiDAR-based surroundings sensors, radar sensors, or also ultrasonic sensors, have specific advantages and also disadvantages which have an influence on the detection of the surroundings. Thus, optical cameras are distinguished by a high resolution and a long range and enable reliable identification of objects in the surroundings of the vehicle. However, they have weaknesses in the determination of distances to the objects, and their performance can drop in specific environmental conditions such as fog or precipitation. LiDAR-based surroundings sensors, in contrast, are very reliable in the determination of the distance of objects and have a high tolerance for various environmental conditions, but are comparatively costly and have a low horizontal angle resolution. A reliable identification of objects in the surroundings of the vehicle is also currently not possible. The statements for the LiDAR-based surroundings sensors apply comparably to radar sensors. Ultrasonic sensors are in turn only suitable for short ranges and only have a very minor directional characteristic, while they are available particularly cost-effectively and are already widespread in current vehicles. Among other things, a reasonable price is important for the mass distribution of driver assistance systems, due to which a use of LiDAR-based surroundings sensors is currently excluded.

Sensor systems having various types of surroundings sensors, which can be provided cost-effectively overall, are already known in the prior art for use in various assistance systems. In this case, for example, an optical front camera mounted behind a windshield of the vehicle is combined with ultrasonic sensors mounted along the vehicle sides. However, this solution is also typically not sufficient to provide a desired performance and reliability, for example for autonomous driving according to level 4. Using an increasing number of surroundings sensors, for example multiple optical cameras, the performance of the sensor systems for surroundings detection can be increased. However, such sensor systems are not suitable for current mass-produced vehicles due to the costs for the sensor systems and the additional demands for the processing of the sensor data provided by these surrounding sensors.

This also applies to applications in surroundings known per se. Thus, for example, automatic parking systems are known in which vehicles independently drive to their parking space in a property area, for example. Such systems currently require monitoring by the vehicle driver. This monitoring can also take place from outside the vehicle here. This corresponds to autonomous driving according to level 2. However, autonomous driving in the sense of level 4 cannot yet be implemented in this way. This also applies to current valet parking systems. There are approaches for improving the performance in surroundings detection by additional external surroundings sensors. Such external surroundings sensors are part of an infrastructure in the area in which the vehicle is maneuvered. However, these external surroundings sensors are also associated with high additional costs. This can also only take place with consent of an owner of the infrastructure, for example a property owner, and is difficult to implement in particular in public areas. In addition, the question of the responsibility between vehicle producer and a provider of external surroundings sensors is difficult to clarify.

To simplify the requirements for data processing in the vehicle, it is possible in principle to carry out the automatic maneuvering in a cloud-based manner. In this case, items of sensor information are transmitted from surroundings detection sensors of the vehicle to a cloud server and processed there. However, this fails in practice due to the amounts of data to be transmitted.

In practice, it is therefore typical in the automatic maneuvering of a vehicle that the vehicle driver monitors the maneuvering and grants clearances so that the vehicle can continue to maneuver. This can take place, for example, in the manner of a continuous confirmation by the vehicle driver, wherein the maneuvering is stopped if the confirmation is absent. Alternatively or additionally, the vehicle driver can check items of information provided for the automatic maneuvering, for example before or during the maneuvering. The vehicle driver can also grant the clearances from outside the vehicle, however it is necessary for the vehicle driver to be located at least in the vicinity of the vehicle.

Proceeding from the above-mentioned prior art, the invention is therefore based on the object of specifying a method for cloud-based automatic maneuvering of a vehicle along a predetermined driving route, a method for clearance-based automatic maneuvering of a vehicle along a predetermined driving route, a driver assistance system for a vehicle, which carries out one of the above methods, and a corresponding cloud-based driver assistance system, which enable efficient cloud-based maneuvering of the vehicle with a high level of reliability, in particular for limited applications such as autonomous parking of the vehicle.

The object is achieved according to the invention by the features of the independent claims. Advantageous embodiments of the invention are specified in the dependent claims.

According to the invention, a method is therefore specified for determining step-by-step clearances for a vehicle for automatic maneuvering along a predetermined driving route from a current vehicle position to a destination point, wherein the vehicle comprises a sensor system having at least one optical camera for monitoring the surroundings in the direction of travel of the vehicle, comprising the steps of providing a current video image of the optical camera at the current vehicle position, determining the clearance for automatic maneuvering of the vehicle along the predetermined driving route based on an automatic comparison of items of image information from a controlled area of the video image to items of reference image information from the controlled area originating from a previously recorded comparison image, and outputting the determined clearance for automatic maneuvering of the vehicle along the predetermined driving route for a step which corresponds to the current video image.

According to the invention, furthermore a method is specified for clearance-based automatic maneuvering of a vehicle along a predetermined driving route from a current vehicle position to a destination point, wherein the vehicle comprises a sensor system having at least one optical camera for monitoring the surroundings in the direction of travel of the vehicle, wherein the method comprises determining step-by-step clearances for automatic maneuvering of the vehicle along the predetermined driving route using the above method.

According to the invention, a driver assistance system for a vehicle is also specified, wherein the driver assistance system is designed to carry out the above method.

According to the invention, a cloud-based driver assistance system having at least one vehicle and a cloud-based clearance server is also specified, wherein the at least one vehicle and the cloud-based clearance server are connected to one another via a data connection, and the cloud-based driver assistance system is designed to carry out the above method.

The basic concept of the present invention is thus to enable the step-by-step clearance for a vehicle for automatic maneuvering of the vehicle along a predetermined driving route originating from the sensor system of the vehicle, wherein monitoring of the surroundings of the vehicle in the direction of travel is carried out based on the optical camera. Step-by-step clearances can be generated automatically, so that clearance-based automatic maneuvering can be carried out. The clearances can be generated based on the automatic comparison of the items of image information from the controlled area of the video image to the corresponding items of reference image information from the controlled area. These clearances can therefore be used, for example, like previously typical clearances which are generated by the vehicle driver, in order to enable the automatic maneuvering of the vehicle. The vehicle can therefore maneuver automatically in or through the controlled area. By iteratively carrying out the method, an iterative check of the driving route up to the destination point can take place, and the vehicle can maneuver automatically up to the destination point.

The communication of the vehicle with the cloud-based clearance server via the data connection can be carried out particularly efficiently here, since the amount of data to be transmitted is reduced due to the observation of only the controlled area. The transmission of the items of image information to the clearance server is restricted to the controlled area and can thus be accelerated due to the reduced amount of data to be transmitted. The processing of the corresponding items of image information can also be carried out in a short time due to the observation of only the controlled area. As a result, low latency times can be achieved in the overall data processing from the provision of the current video image to the reception of the clearance in the vehicle.

In particular, in specific applications a driving route having a sufficient length can therefore be detected and cleared, so that, for example, autonomous driving in the sense of level 4 can be achieved. This applies, for example, to applications for autonomously parking the vehicle, in which a driving route is predetermined or is determined beforehand, for example, so that only a small area of the surroundings is to be monitored. A low driving speed can also be predetermined in such applications, so that the controlled area only changes slowly along the driving route.

The method can be carried out particularly advantageously, for example, in current applications for autonomous driving according to level 2, which require monitoring by the vehicle driver. A confirmation of the monitoring by the vehicle driver by the corresponding clearance to move the vehicle along the predetermined driving route can be replaced here by the automatically determined clearance. Accordingly, existing driver assistance systems for autonomous driving according to level 2 can be easily expanded for autonomous driving, for example according to level 4, without greater interventions being required in the corresponding application for autonomous driving. It is only necessary to additionally implement the described method for determining step-by-step clearances and use the reception of the clearance to move the vehicle along the predetermined driving route from the clearance server as a confirmation of the monitoring by the vehicle driver.

The vehicle can be any vehicle which is designed for automatic driving or autonomous driving.

The automatic maneuvering relates to at least partially autonomous movement of the vehicle. For this purpose, the driving route can be predetermined, for example by a journey along the driving route by a human vehicle driver, so that the driving route can be learned. The predetermined driving route connects the current vehicle position and the destination point. The predetermined driving route specifies a route course for reaching the destination position. Due to the predetermined driving route, the items of reference image information are available for comparison to the image information of the current video image.

The sensor system comprises at least one optical camera for monitoring the surroundings of the vehicle in the direction of travel of the vehicle. The optical camera can be attached, for example, behind a windshield of the vehicle to monitor the surroundings in front of the vehicle, which corresponds to the typical forward driving. Accordingly, an optical camera which is oriented toward the rear side of the vehicle is required in the case of reverse driving. Such optical cameras typically have a large field of view of 90° or 120° up to 180°, so that the optical camera can detect the driving route at least in a close to moderate distance of, for example, up to a few tens of meters.

The sensor system can comprise additional surroundings detection sensors, for example as ultrasonic sensors, to carry out additional monitoring of the surroundings of the vehicle. The reliability when maneuvering the vehicle can thus be additionally improved.

The provision of the current video image of the optical camera at the current vehicle position corresponds to the provision of an image or sequence of images in the manner of a video. The current video image can be coded in any arbitrary way or can be present in a raw format. Properties of the provided current video image are defined in principle by properties of the optical camera.

Determining the clearance for automatic maneuvering of the vehicle along the predetermined driving route based on an automatic comparison of items of image information from a controlled area to items of reference image information from a controlled area originating from a previously recorded comparison image enables differences between the items of image information of the two controlled areas to be identified automatically. The items of reference image information for the controlled area represent it without obstacles relevant for the vehicle. An implicit clearance is thus assumed for the items of reference image information. If there is a deviation of the received items of image information from the items of reference image information, a presence of an obstacle can be presumed, so that no clearance is generated. In order to nonetheless be able to grant a clearance in case of a deviation, the type of the deviation can be determined. Since the controlled area is defined by the driving route, it can be determined by the automatic comparison whether the vehicle can be moved through the controlled area.

The items of reference image information can be stored in the vehicle or in the cloud-based clearance server depending on the design of the method. The method can be carried out, for example, essentially autonomously in the vehicle, i.e. the items of reference image information are stored in the vehicle. The items of reference image information can also be generated by the respective vehicle itself. Alternatively, the items of reference image information can be transmitted from the cloud-based clearance server to the vehicle and provided permanently there. Alternatively, the items of reference image information can be provided dynamically, for example depending on the position of the vehicle, by the cloud-based clearance server. Parts of the method can also be carried out in the cloud-based clearance server. For this purpose, for example, the items of image information can be transmitted from the vehicle to the cloud-based clearance server.

The controlled area corresponds to an area for which the clearance is determined by the automatic comparison of the items of image information of the video image to the items of reference image information of the comparison image. The controlled area can comprise the entire video image, or only a section thereof. Different areas of the current video image can form the controlled area here. The controlled area can also change, for example depending on driving parameters, and, for example, the controlled area can be selected in different sizes for different speeds.

The clearance for automatically maneuvering the vehicle along the predetermined driving route represents a clearance for traveling in the observed controlled area. The vehicle can therefore maneuver automatically in or through the controlled area. An iterative check of the entire driving corridor up to the destination point can take place due to the iterative performance of the method.

The clearance-based automatic maneuvering of the vehicle along the predetermined driving route according to the received clearance relates to autonomous driving of the vehicle. The vehicle can carry out a lateral and longitudinal control here. The automatic maneuvering of the vehicle is carried out here based on the determined clearances, using which the vehicle maneuvers automatically along the predetermined driving route. The clearances are granted step-by-step depending on the respective video images which are provided by the optical camera.

The method can, on the one hand, be carried out in the vehicle itself, i.e. in the driver assistance system. Alternatively, the method can be carried out using a cloud-based driver assistance system, which is formed by the at least one vehicle together with the cloud-based clearance server. Parts of the method are therefore carried out in the respective vehicle, and the other steps of the method are carried out by the clearance server, which is positioned in the cloud.

The cloud-based clearance server is an arbitrary server per se, which is connected via the data connection to the corresponding vehicle. It is only important to carry out the required method steps, which are assigned to the clearance server. The clearance server typically comprises processing means, storage means, and communication means, wherein the communication means are used to establish the data connection.

The data connection is used to transmit data, in this case the items of image information from the controlled area and the clearance, between the at least one vehicle and the clearance server. The data connection is therefore a fundamentally arbitrary communication connection between vehicle and clearance server, which can comprise a combination of fundamentally arbitrary transmission media and protocols. It represents a typical communication means and as such is unimportant for the function of the cloud-based driver assistance system. An arbitrary data connection can be used here, wherein in a packet-oriented data transmission, which is currently typical, arbitrary transmission paths can be used for the data transmission without the at least one vehicle or the clearance server having to have an influence thereon. Such an influence typically also cannot be exerted.

The video image can be, for example, a single image, also known as a frame, which is recorded and provided by the optical camera. Alternatively, the video image can be a moving image based on a sequence of single frames, i.e. video sequences are observed.

The items of image information can comprise pixels of the current video image in the controlled area, thus a part of the currently provided video image. The items of image information can alternatively or additionally comprise pixels of the current video image in the controlled area which are processed or preprocessed in an arbitrary manner or can be based thereon. In this way, for example, relevant parts of the current video image in the controlled area can be determined and compared. The items of image information can comprise items of information, for example items of semantic information, with respect to contents of the current video image in the controlled area.

In an advantageous design of the invention, the method comprises a step of matching the items of image information from the controlled area with the items of reference image information from the controlled area. In practice, localization errors can occur, or the localization of the vehicle is not sufficiently accurate, which can obstruct or even make impossible a comparison of the received items of image information to the items of reference image information for the respective current controlled area. The localization of the vehicle can be improved by the matching of the items of image information. The items of image information can therefore be reliably compared by the matching of the items of image information and the occurrence of errors can be reduced. The matching of the items of image information with the items of reference image information takes place before the determination of a clearance based on an automatic comparison of the received items of image information to the items of reference image information. Such methods are also known under the term “visual odometry”.

In an advantageous embodiment of the invention, the matching of the items of image information from the controlled area with the items of reference image information from the controlled area comprises determining a current vehicle position. The matching of the items of image information with the items of reference image information can be carried out efficiently based on the vehicle position.

In an advantageous embodiment of the invention, the determination of a current vehicle position comprises determining the current vehicle position based on a reception of signals from a satellite navigation system, in particular using a differential global positioning system, and/or providing items of odometry information of the vehicle, and/or identifying landmarks along the predetermined driving route of the vehicle, and/or determining the current vehicle position using a system for visual simultaneous position determination and mapping. Various ones of the above methods for determining the position of the vehicle can be used alone or in combination for determining the current vehicle position. This relates both to the currently maneuvered or maneuvering vehicle and the provision of the items of reference image information. The use of signals from a satellite navigation system is widespread, in particular for vehicle navigation. The accuracy of the position determination can be increased from an accuracy of a few meters to an accuracy of less than half a meter or less by the use of a differential global positioning system. The items of odometry information of the vehicle can be provided by odometry sensors, for example by a wheel revolution sensor (wheel tics) and also by a sensor for detecting a current steering angle. The items of odometry information enable a very accurate determination of position changes of the vehicle. Since the odometry sensors typically have short measuring cycles and are therefore faster than, for example, satellite navigation systems, the vehicle position can be determined particularly reliably by a combination of both types of position determination. Landmarks can contribute to the exact determination of the vehicle position and improve the position determination. For example, aruco codes are known as landmarks. Visual simultaneous position determination and mapping is known under the term “visual simultaneous localization and mapping” (V-SLAM) and is based on a position determination originating from camera images offset in time, by which a position change of the vehicle can be determined.

In an advantageous embodiment of the invention, the provision of items of odometry information of the vehicle comprises providing items of visual odometry information of the vehicle, in particular based on a ground structure and/or providing sensor signals from at least one odometry sensor of the vehicle. Ground structures such as a paving having specific rocks can be identified in particular at short distances with a high degree of detail and enable reliable position determination on the basis of a shape of their structure. High accuracies in the position determination can be achieved on the basis of typical structure sizes of, for example, paving stones in the range of approximately 10 to 20 cm. A movement of features, for example of pixels, can be reliably detected on the basis of the ground structure, i.e. a pixel flow is detected. Deviations in the pixel flow are representative of relief differences and can be evaluated very reliably. Pixel flow is tolerant to typical error sources such as color, lighting, or ground moisture.

In an advantageous embodiment of the invention, in the event of a lack of clearance, the method comprises a step of transmitting the items of image information from the controlled area and the items of reference image information from the controlled area to an operator to determine the clearance. Therefore, even in the event of an error in the determination of the clearance, i.e. if the clearance is not automatically granted based on the comparison of the items of image information to the items of reference image information from the controlled area, a clearance can still take place if the operator determines that the vehicle can be maneuvered in the controlled area. Intervention of the vehicle driver is therefore not necessary. The operator can in principle be located at any arbitrary position. For example, the operator can be directly connected to the clearance server or can determine the clearance “remotely”. In principle, however, it can be sufficient if an occupant of the vehicle acts as the operator. Thus, for example, the items of image information from the controlled area and the items of reference image information from the controlled area can be transmitted to a user interface of the vehicle, and the operator can check and grant the clearance via the user interface.

In an advantageous embodiment of the invention, the method comprises, upon a clearance by the operator, an adaptation of the items of reference image information based on the items of image information from the controlled area. Thus if the clearance is carried out by the operator, the system can be adapted by adapting the items of reference image information so that the clearance can take place automatically in the observed controlled area upon a renewed comparison of items of image information and items of reference image information. A machine learning process preferably takes place. If the items of reference image information are stored on the cloud-based clearance server, all connected vehicles can jointly contribute to improving and adapting the items of reference image information.

In an advantageous embodiment of the invention, the method comprises a step of traveling along the driving route to learn the driving route, in particular as a trajectory, comprising providing video images of the optical camera along the traveled driving route, and storing items of image information from the controlled area as items of reference image information from the controlled area or at least a detail of the video images as comparison images. The traveling along the driving route and therefore the learning of the driving route can be carried out using any arbitrary vehicle. As soon as a driving route has been traveled a first time, the items of reference image information are thus ready for the corresponding vehicle. If the clearance server is used, the items of reference image information can also be provided for other vehicles, so that the method for determining step-by-step clearances and for automatically maneuvering along a predetermined driving route can be carried out by all vehicles.

The more frequently the driving route has been traveled, the better is the quality of the items of reference image information, and the more often and more reliably an automatic check and clearance can be carried out. The trajectory comprises, in addition to the driving route, items of movement information for the maneuvering, for example speeds or accelerations.

In an advantageous embodiment of the invention, the method comprises transmitting the items of image information from the controlled area as items of reference image information from the controlled area or at least a detail of the video images as comparison images to a cloud-based clearance server. The items of reference image information are therefore stored in the cloud-based clearance server so that they can be provided to various vehicles. The items of reference image information can also be provided jointly by various vehicles in the cloud-based clearance server. The items of reference image information can be the items of image information as are transferred by the vehicles to the cloud-based clearance server, or the cloud-based clearance server can carry out processing of the transmitted items of image information and, for example, determine the items of reference image information from the comparison images.

The items of image information can be stored as the items of reference image information and/or at least the detail of the video images can be stored as comparison images, so that these (details of the) comparison images can be used as image information, or the items of image information can be generated therefrom in a desired form at an arbitrary time.

In an advantageous embodiment of the invention, the method comprises determining the items of image information from the controlled area based on a flow of image elements, in particular pixels, based on at least two single video images of the optical camera. Such items of image information can generate a three-dimensionality of the items of image information, which improves the determination of the clearance based on an automatic comparison of the items of image information from the controlled area to the items of reference image information from the controlled area. The principle is based on image elements at different distances experiencing different relative position changes in relation to the optical camera upon a position change of the vehicle.

In an advantageous embodiment of the invention, the method comprises steps for identifying a driving corridor in the current video image, and for identifying the controlled area along the driving corridor, in particular in the driving corridor, depending on the driving route and/or driving parameters of the vehicle. The identification of the driving corridor in the current video image can be carried out, for example, in the manner of a projection or an overlay of the driving corridor in the current video image depending on the position and alignment of the vehicle. The driving corridor can be defined as a single line, in particular as a center line, or having lateral boundary lines. The driving corridor can preferably be identified depending on the driving route in the current video image so that, on the one hand, an amount of data to be processed can be reduced and, on the other hand, it is ensured by the driving corridor that the controlled area is selected so that it is relevant for the maneuvering of the vehicle. Processing of data which are not relevant for the maneuvering of the vehicle can be omitted. Accordingly, depending on the design of the method, requirements for the data transmission between the corresponding vehicle and the cloud-based clearance server can be reduced further.

The identification of the controlled area along the driving corridor can be carried out, for example, using a window having predetermined dimensions and a predetermined position in relation to the optical camera. This window can thus be moved along the driving corridor when the vehicle moves. In a driving corridor defined by lateral boundary lines, the controlled area can be identified between these boundary lines and two distance limits.

The identification of the controlled area can be carried out depending on the driving route, so that the controlled area can change with the driving route depending thereon, i.e. different areas of the current video image are identified as the controlled area. The identification of the controlled area can be carried out depending on driving parameters of the vehicle, so that the controlled area can change depending on the driving parameters. The controlled area can thus be selected to be different sizes, for example for different speeds.

In an advantageous embodiment of the invention, the method comprises determining items of brightness information of the current video image of the optical camera, and the identification of the controlled area takes place with additional consideration of the determined items of brightness information of the current video image and/or the method comprises determining the items of image information from the controlled area in consideration of determined items of brightness information of the current video image. Due to the identification of the controlled area based on the determined items of brightness information, for example, the controlled area can be selected so that it only contains informative items of image information. The processing of the current video image of the optical camera can thus be simplified and therefore also accelerated. Based on the determined items of brightness information of the current video image, for example, the items of image information from the controlled area can be partially filtered if no distinguishable image contents are present due to a deficiency of light or also overexposure. The brightnesses can arise due to a static illumination and also based on light cones of vehicles, the ego vehicle or also of third-party vehicles. The identification of the controlled area based on the determined items of brightness information of the current video image can be carried out directly in the vehicle, by which the amount of data of the items of image information to be transmitted from the controlled area can be reduced during a subsequent transmission to the cloud-based clearance server. Alternatively, after the transmission of items of image information from the controlled area to the clearance server, the controlled area can be adapted.

In an advantageous embodiment of the invention, the method comprises compensating the items of image information from the controlled area and/or the items of reference image information from the controlled area for different weather conditions, in particular ground moisture, snow, or hail. Ground moisture can occur, for example, in the form of local puddles. In addition, a damp underlying surface can have a different color than a dry underlying surface. In particular with uneven levels of moisture of the underlying surface, color patterns can thus arise which can result in problems, for example an incorrect identification of objects. This applies accordingly to puddles. A color change of the underlying surface can also result overall in problems, for example due to the aforementioned moisture or a covering by snow or ice. Due to the manifold types of possible different weather conditions and the color changes resulting therefrom, optical differences can result between the current video image and the comparison image, due to which the automatic comparison of the received items of image information to the items of reference image information becomes susceptible to errors, and problems can arise when determining the clearance, i.e. the clearance cannot be readily granted. A neural network is preferably used to learn and apply the compensating of the items of image information or the items of reference image information for different weather conditions. The training can be carried out for the items of reference image information based on a plurality of training data, i.e. various items of image information as items of reference image information. The compensating can be generally trained, i.e. independently of a specific controlled area, or individually for each of different controlled areas. The compensating can be carried out for the items of image information from the controlled area directly in the vehicle, or, in the case of the transmission of the items of image information to the clearance server, it can be carried out or prompted by the clearance server after the transmission. This applies accordingly to the provided items of reference image information from the controlled area, which can be based, for example, on items of image information provided by various vehicles.

In an advantageous embodiment of the invention, the method comprises compensating the items of image information from the controlled area and/or the items of reference image information from the controlled area for shadows. Shadows can occur in sunshine or in general depending on an illumination situation at arbitrary objects, due to which a color of the underlying surface changes. Color patterns can thus arise, which can result in problems, for example an incorrect identification of objects. Due to the variety of possible shapes of shadows and the color changes resulting therefrom, optical differences can result between the current video image and the comparison image, due to which the automatic comparison of the received items of image information to the items of reference image information typically becomes susceptible to errors and problems can arise in the determination of the clearance, i.e. the clearance cannot be readily granted. A neural network is preferably used to learn and apply the compensating of the items of image information or the items of reference image information for shadows. The training can be carried out for the items of reference image information based on a plurality of training data, i.e. various items of image information as items of reference image information. The compensating can be generally trained, i.e. independently of a specific controlled area, or individually for each of different controlled areas. The compensating can be carried out for the items of image information from the controlled area directly in the vehicle, or, in the case of the transmission of the items of image information to the clearance server, it can be carried out or prompted by the clearance server after the transmission. This applies accordingly to the provided items of reference image information from the controlled area, which can be based, for example, on items of image information provided by various vehicles. It is possible to distinguish here between unmoving objects and moving objects for the compensation of shadows. With unmoving objects, such as buildings, signs, or trees, the compensation can be carried out reliably, even if the objects move due to wind, for example. With moving objects such as people passing by or birds flying over, a compensation can be necessary since these shadows typically move out of the controlled area in a short time.

In an advantageous embodiment of the invention, the compensating of the items of image information from the controlled area and/or the items of reference image information from the controlled area for shadows comprises time-dependent compensating of the items of image information from the controlled area and/or the items of reference image information from the controlled area for shadows. A local time of day specifies solar altitude information, from which a shadow to be expected can be determined in detail. Different shadows based on the same objects can thus be taken into consideration, for example in the morning or evening. Together with a date, precise information results with respect to the solar altitude, for example also a length of shadows. In addition, position information can be used to carry out the compensation for arbitrary positions of the vehicle and, for example, to determine a local time of day automatically.

In an advantageous embodiment of the invention, the method comprises steps of transmitting the items of image information from the controlled area to a cloud-based clearance server, and transmitting the determined clearance to move the vehicle along the predetermined driving route from the cloud-based clearance server to the vehicle, and wherein the previously recorded comparison image is stored in the cloud-based clearance server and the determination of the clearance comprises a determination of the clearance in the cloud-based clearance server. This method is carried out accordingly using the cloud-based driver assistance system. The transmission of items of image information from the controlled area to the clearance server takes place via the data connection in a fundamentally arbitrary manner. In order to maneuver the respective vehicle reliably, the data connection preferably enables a data transmission with a low latency. The determination of the clearance is outsourced here to the cloud-based clearance server, so that resources thereof can be used. Accordingly, few resources are to be stocked in the vehicles. In particular, the items of reference image information can advantageously be provided in the cloud-based clearance server, since in this way a transmission of the items of reference image information to the vehicle(s) can be omitted. Only the items of image information from the controlled area of the video image are to be transmitted in order to determine the clearance. Due to the transmission of the determined clearance to move the vehicle along the predetermined driving route from the clearance server to the vehicle, the corresponding clearance for traveling along the observed controlled area can be used there. The data volume to be transmitted can be kept small by a skilled selection of the controlled area.

In an advantageous embodiment of the invention, the method comprises compressing the items of image information from the controlled area before transmitting the items of image information to the cloud-based clearance server and decompressing the items of image information from the controlled area after transmitting the items of image information to the cloud-based clearance server. The data transmission via the data connection can be further reduced by the compression of the items of image information. Various methods for compressing items of image information are known per se and therefore do not have to be explained in detail here.

In an advantageous embodiment of the invention, the items of reference image information are stored in a cloud-based clearance server and the method comprises a step of receiving the items of reference image information from the controlled area originating from the previously recorded comparison image from the cloud-based clearance server, wherein the determination of the clearance comprises a determination of the clearance in the vehicle. The items of reference image information can thus be made available for all vehicles on the cloud-based clearance server and transmitted from there to the vehicles. The items of reference image information can be transmitted “off-line”, i.e. independently of current maneuvering of the vehicle along the predetermined driving route. Alternatively, the items of reference image information for a driving route can be transmitted upon reaching a point of the driving route. Further alternatively, the reference image information can be transmitted individually for the determination of each clearance.

In an advantageous embodiment of the invention, the method comprises an additional step of requesting the transmission of the items of reference image information from the controlled area originating from the previously recorded comparison image from the cloud-based clearance server. It can thus be ensured that only required items of reference image information. Thus, for example, upon reaching the starting point of the driving route, the items of reference image information for maneuvering the vehicle along the entire driving route can be requested. Alternatively, for each clearance the corresponding items of reference image information can be requested in each case currently from the cloud-based clearance server. Furthermore, for example, items of reference information stored in the vehicle can be monitored with respect to their timeliness, for example depending on a storage date. If the stored items of reference information are no longer current, a request to transmit these items of reference image information can be sent to the cloud-based clearance server in order to replace the items of reference image information which are no longer current with current items of reference image information. If the items of reference image information are locally stored in the vehicle, for example, a request can be sent if the clearance cannot be granted upon the automatic comparison of the items of image information to the items of reference image information for the controlled area. If more current items of reference image information are present, the comparison can therefore be carried out again.

In an advantageous embodiment of the invention, the method comprises compressing the items of reference image information from the controlled area before transmitting the items of reference image information from the cloud-based clearance server and decompressing the received items of reference image information from the controlled area after receiving the items of reference image information from the cloud-based clearance server. The data transmission via the data connection can be further reduced by the compression of the items of reference image information. Various methods for compressing items of image information are known per se and therefore do not have to be explained in detail here. To save storage space, the decompression of the received items of reference image information may only be carried out if needed, i.e. the items of reference image information received from the cloud-based clearance server are initially stored in the compressed state.

In an advantageous embodiment of the invention, the method for clearance-based automatic maneuvering of the vehicle is carried out based on a control of the vehicle by an external server, in particular for automatic valet parking type 2, a control of the vehicle based on a method for visual automatic localization and mapping, V-SLAM, or a control of the vehicle based on a method for automatic localizing and mapping using at least one surroundings sensor for generating a point cloud of the surroundings of the vehicle, in particular using at least one radar sensor and/or one LiDAR-based surroundings sensor. Using corresponding methods, vehicles can already maneuver in practice automatically along predetermined driving routes, so that an expansion can be implemented with little effort using the method for determining step-by-step clearances for the vehicle for automatic maneuvering and also using the method for clearance-based automatic maneuvering of a vehicle. The driving route or a corresponding trajectory can be determined, depending on the method and its embodiment, in the vehicle, specifically the corresponding driver assistance system, or on the server side.

In an advantageous embodiment of the invention, the method for clearance-based automatic maneuvering of a vehicle along a predetermined driving route from a current vehicle position to a destination point is carried out for automatic valet parking or for trained parking using a previously learned trajectory for driving along the driving route. Corresponding applications for current vehicles are already partially in use, so that an expansion can be implemented with little effort using functions for determining step-by-step clearances for the vehicle for automatic maneuvering and also for clearance-based automatic maneuvering of a vehicle. The driving route or a corresponding trajectory can be determined, depending on the specific application and its embodiment, in the vehicle, specifically the corresponding driver assistance system, or on the server side.

In an advantageous embodiment of the invention, the method comprises receiving a position of the vehicle, in particular based on the reception of signals of a global satellite navigation system, GNSS, and the method comprises selecting a driving route based on the received position of the vehicle. The position of the vehicle is not used here for navigation, but rather for identifying the driving route, in order to be able to determine the clearances along this driving route. Thus, for example, the associated items of reference image information can be loaded from a memory in the vehicle, the items of reference image information can be decompressed, or the items of reference image information for the driving route are transmitted by the cloud-based clearance server, in which they are stored, and received by the vehicle or the driver assistance system. Currently, the systems NAVSTAR GPS (Global Positioning System), GLONASS (global satellite navigation system), Galileo, and Beidou are in operation as global satellite navigation systems.

Features and advantages of the described method can be readily transferred to the described system and vice versa. Individual steps of the method can also be carried out in an order which is arbitrary per se. The method is not restricted to the sequence of the method steps described by way of example, insofar as this results in an obvious manner from the description for a person skilled in the art.

The invention is explained in more detail below with reference to the attached drawing on the basis of preferred embodiments. The features shown can each constitute an aspect of the invention both individually and in combination. Features of different exemplary embodiments can be transferred from one exemplary embodiment to another.

### In the figures:

FIG. 1 shows a schematic view of a cloud-based driver assistance system, which is represented here by way of example by a vehicle and a cloud-based clearance server, wherein the vehicle and the cloud-based clearance server are connected to one another via a data connection, and wherein the vehicle comprises a sensor system having at least one optical camera for monitoring the surroundings in the direction of travel of the vehicle, according to a first preferred embodiment,

FIG. 2 shows a schematic representation of the function of the cloud-based driver assistance system from FIG. 1 for carrying out a method for automatically maneuvering the vehicle along a predetermined driving route using the cloud-based clearance server, with a driving route and a controlled area,

FIG. 3 shows a schematic representation of a position determination of the vehicle from FIG. 1 based on various types of the position determination,

FIG. 4 shows a detailed schematic view of a position determination of the vehicle based on a visual simultaneous position determination and mapping on the basis of different perceived pixels,

FIG. 5 shows a schematic representation of a controlled area in an exemplary current video image in consideration of an illumination situation,

FIG. 6 shows a further schematic representation of a controlled area in an exemplary current video image in consideration of an illumination situation,

FIG. 7 shows a detailed schematic representation of an effect of different weather conditions and ground moisture resulting therefrom, which results in different ground coloration,

FIG. 8 shows a schematic representation of an effect of different weather conditions and ground moisture resulting therefrom, which results in different ground colorations in the case of uneven drying of the ground,

FIG. 9 shows a schematic representation of an effect of different weather conditions and puddle formation resulting therefrom,

FIG. 10 shows a schematic representation of an effect of casting shadows, which results in different ground coloration in relation to an area without shadows,

FIG. 11 shows a further schematic representation of an effect of casting shadows, which results in different ground coloration in relation to an area without shadows,

FIG. 12 shows a schematic representation of exemplary surroundings of the vehicle having a homogeneous, smooth ground structure,

FIG. 13 shows a schematic representation of exemplary surroundings of the vehicle having a coarse-pored ground structure,

FIG. 14 shows a schematic representation of exemplary surroundings of the vehicle having a ground structure having a first type of ground paving,

FIG. 15 shows a schematic representation of exemplary surroundings of the vehicle having a ground structure having a second type of ground paving,

FIG. 16 shows a flow chart of a method for determining step-by-step clearances for a vehicle for automatic maneuvering along a predetermined driving route from a current vehicle position to a destination point, in correspondence with the cloud-based driver assistance system of the first embodiment from FIG. 1,

FIG. 17 shows a schematic representation of exemplary surroundings of the vehicle having a ground structure having a third type of ground paving and a pixel flow,

FIG. 18 shows a flow chart of a method of a second embodiment for determining step-by-step clearances for a vehicle for automatic maneuvering along a predetermined driving route from a current vehicle position to a destination point, and

FIG. 19 shows a flow chart of a method of a third embodiment for determining step-by-step clearances for a vehicle for automatic maneuvering along a predetermined driving route from a current vehicle position to a destination point.

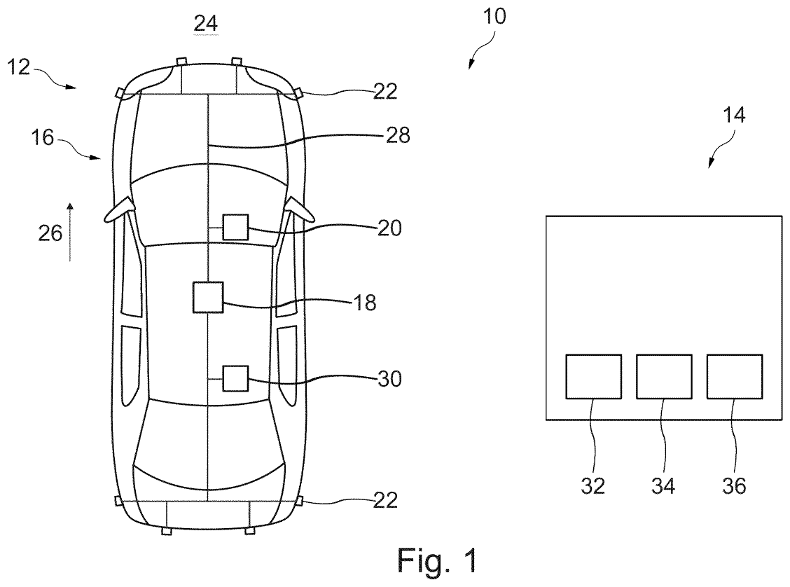

FIG. 1 shows a cloud-based driver assistance system 10 according to a first preferred embodiment.

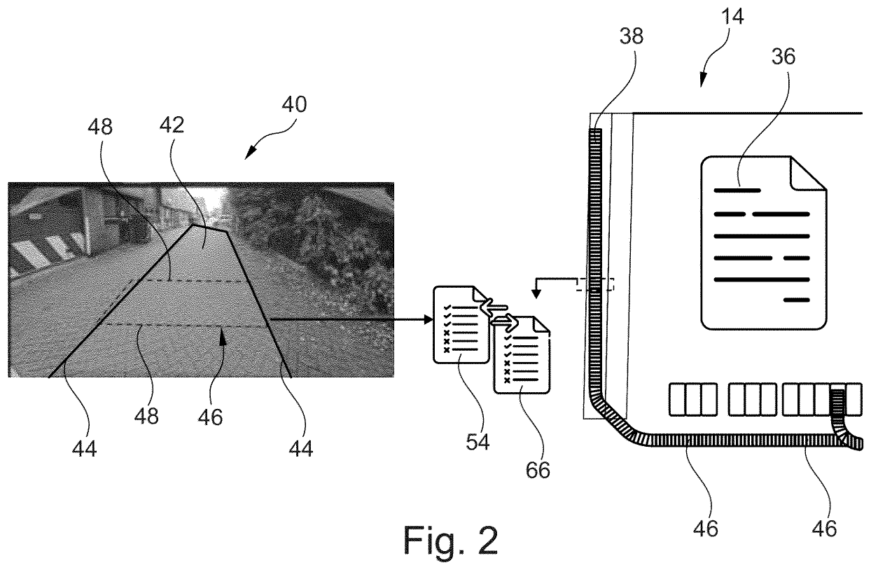

The cloud-based driver assistance system 10 is shown in FIGS. 1 and 2 with one vehicle 12, but can comprise further vehicles 12 which are not shown here. The cloud-based driver assistance system 10 furthermore comprises a cloud-based clearance server 14.

The vehicle 12 comprises an assistance system 16 for autonomously parking the vehicle 10, in which a driving route 38 is predetermined or is determined beforehand, for example. The assistance system 16 comprises a control unit 18 which carries out the method. The assistance system 16 additionally comprises a sensor system 20, 22 having an optical camera 20 and a plurality of ultrasonic sensors 22, which are attached to the respective vehicle 12, for monitoring the surroundings 24 of the vehicle 12. The optical camera 20 is attached behind a windshield of the vehicle 12 to monitor the surroundings 24 in a direction of travel 26 in front of the vehicle 12. The control unit 18 and the sensor system 20, 22 are connected to one another via a data bus 28. The data bus 28 can be embodied, for example, according to a standard typical in the automotive sector such as CAN, LIN, LON, or FlexRay.

The vehicle 12 comprises a communication unit 30 for communication with the cloud-based clearance server 14. The cloud-based clearance server 14 comprises corresponding communication means 32 for communication with the vehicle 12. Accordingly, a data connection can be established between the vehicle 12 and the cloud-based clearance server 14 via the communication unit 30 and the communication means 32. The data connection is a fundamentally arbitrary communication connection between vehicle 12 and clearance server 14, which can comprise a dynamic combination of fundamentally arbitrary transmission media and protocols.

The cloud-based clearance server 14 is a server which is arbitrary per se and is connected to the vehicle 12 via the data connection. The clearance server 14 comprises processing means 34 and storage means 36 in addition to the communication means 32 in a typical manner. The storage means 36 store a program for execution by the processing means 34.

The cloud-based driver assistance system 10 is designed to carry out the method described hereinafter for cloud-based automatic maneuvering of the vehicle 12 along the predetermined driving route 38 from a current vehicle position to a destination point. The method is based on determining step-by-step clearances for the vehicle 12 for automatic maneuvering along the predetermined driving route 38. Such a driving route 38 is shown by way of example in FIG. 2.

The cloud-based driver assistance system 10 carries out the method as trained parking using a previously learned trajectory for driving along the driving route 38, wherein the control of the vehicle 12 is generally carried out based on a method for visual automatic localizing and mapping, V-SLAM.

The method begins in step S100 with providing a current video image 40 from the optical camera 20 at the current vehicle position. Such a video image 40 is shown by way of example in FIG. 2.

The current video image 40 is provided here from the optical camera 20, for example as a single image, also known as a frame, which is recorded and provided by the optical camera 20. Alternatively, the video image 40 can be a moving image based on a sequence of single frames, i.e. video sequences are observed. The current video image 40 can be coded in any arbitrary way or can be provided in a raw format. Properties of the provided current video image 40 are defined by properties of the optical camera 20.

Step S110 relates to identifying a driving corridor 42 in the current video image 40. The identification of the driving corridor 42 in the current video image 40 is visualized here as a projection or overlay of the driving corridor 42 in the current video image 40 in FIG. 2. The driving corridor 42 is defined here using lateral boundary lines 44, between which the driving route 38 for the vehicle 12 extends.

Step S120 relates to determining items of brightness information of the current video image 40 from the optical camera 20. Step S120 is optional.

Step S130 relates to identifying a controlled area 46 along the driving corridor 42 depending on the driving route 38 and/or driving parameters of the vehicle 12.

The controlled area 46 is a window having dimensions and a position in relation to the optical camera 30 along the predetermined driving corridor 38. During driving of the vehicle 12, the controlled area 46 moves along the driving corridor 42 with the vehicle 12. The controlled area 46 is defined laterally between the boundary lines 44. Further limits of the controlled area 46 are defined here by a front and a rear distance limit 48.

The position of the controlled area 46 in the respective video image 40 is dependent on the driving route 38, for example in a straight section of the driving route 38 or a curve. Dimensions and position of the controlled area 46 can be adapted depending on driving parameters of the vehicle 12. For example, the controlled area 46 can be in different sizes for different speeds of the vehicle 12.

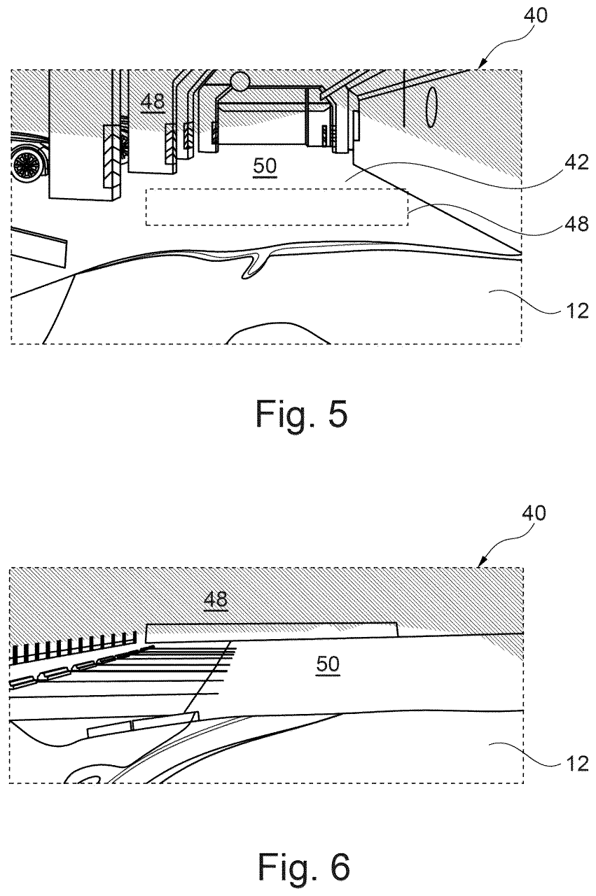

Optionally, depending on optional step S120, the identification of the controlled area 46 can be carried out with additional consideration of the determined items of brightness information of the current video image 40. Due to the additional identification of the controlled area 46 based on the determined items of brightness information, the controlled area 46 can be selected so that it contains the most informative possible items of image information 54. In FIGS. 5 and 6, current video images 40 are shown, as can be provided when driving in a parking garage. Illuminated areas 50 and unilluminated areas 52 result in each case. In FIG. 5, the controlled area 46 is selected by way of example in the driving corridor 42, which is not explicitly shown in FIG. 5, such that it is located in the illuminated area 50.

Step S140 relates to determining items of image information 54 from the controlled area 46 based on a flow of image elements 56, in particular pixels, based on at least two single video images 40 from the optical camera 20.

The principle is illustrated in FIG. 4 and is based on image elements 56 at different distances experiencing different relative position changes upon a position change of the vehicle 12. For this purpose, two image elements 56, which are associated with a box-shaped object 58 and the ground area 60, respectively, are shown by way of example in FIG. 4. At a time t1, the two image elements 56 are located in the field of view 62 of the optical camera 20 on a straight line 64. The vehicle 12 moves here in the direction of travel 26. At time t2, the two image elements 56 are located at different angles in the field of view 62 of the optical camera 20, so that the positions of the two image elements 56 can be determined and the two image elements 56 become distinguishable.

Optionally, depending on optional step S120, the determination of the items of image information 54 from the controlled area 46 can be carried out with additional consideration of the determined items of brightness information of the current video image 40.

Therefore, for example, within the controlled area 46, image points of the video image 40 can be determined as items of image information 54, wherein the image points of the video image 40 are partially filtered based on the determined items of brightness information of the current video image 40 if distinguishable image contents are not present due to a deficiency of light or also overexposure. This applies, for example, to the unilluminated areas 52 in the current video images 40 shown in FIGS. 5 and 6.

Step S150 relates to transmitting the items of image information 54 from the controlled area 46 to the clearance server 14.

Before the transmission of the items of image information 54, they are compressed. The transmission of the items of image information 54 from the controlled area 46 to the clearance server 14 takes place via the data connection in a fundamentally arbitrary manner. Following the transmission of the items of image information 54, they are decompressed again. Various methods for compressing items of image information 54 are known per se and therefore do not have to be explained in detail here.

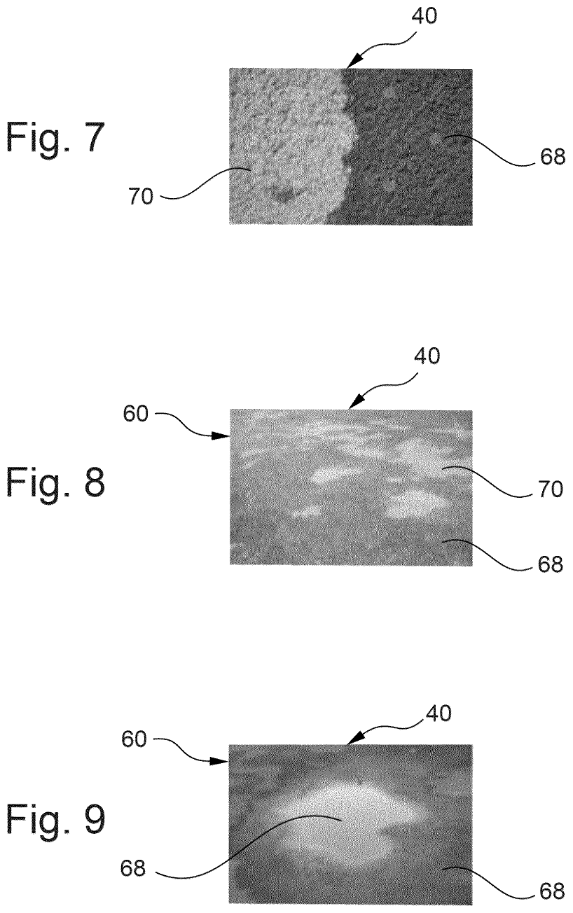

Step S160 relates to compensating the items of image information 54 from the controlled area 46 and/or items of reference image information 66 from the controlled area 46 for different weather conditions, in particular ground moisture, snow, or hail. A damp underlying surface 68 can thus have a different color than a dry underlying surface 70, as shown in FIG. 7. Accordingly, the ground area 60, as shown in FIG. 8, can comprise an irregular pattern having a damp underlying surface 68 and a dry underlying surface 70. Ground moisture can additionally occur in the form of local puddles 72, as shown in FIG. 9. On the ground area 60, a clear visual difference between the puddle 72 shown there and the surrounding damp underlying surface 68 can be seen.

A neural network is preferably used to learn and apply the compensating of the items of image information 54 or the items of reference image information 66 for different weather conditions. The training can be carried out for the items of reference image information 66 based on a plurality of training data, i.e. items of image information 54, which have been transmitted to the clearance server 14. The compensating can be generally trained, i.e. independently of a specific controlled area 46.

Step S170 relates to compensating the items of image information 54 from the controlled area 46 and/or the items of reference image information 66 from the controlled area 46 for shadows 74. The compensating of the items of image information 54 and the items of reference image information 66 for the shadows 74 is carried out depending on time to take into consideration the occurrence of different shadows 74 at different times. A local time of day together with a date indicates solar altitude information, from which a shadow 74 to be expected can be determined with respect to alignment and length. Precise information with respect to the solar altitude results, from which the shadow 74 can be characterized. In addition, position information can be used to carry out the compensation for arbitrary positions of the vehicle 12 and, for example, automatically determine a local time of day.

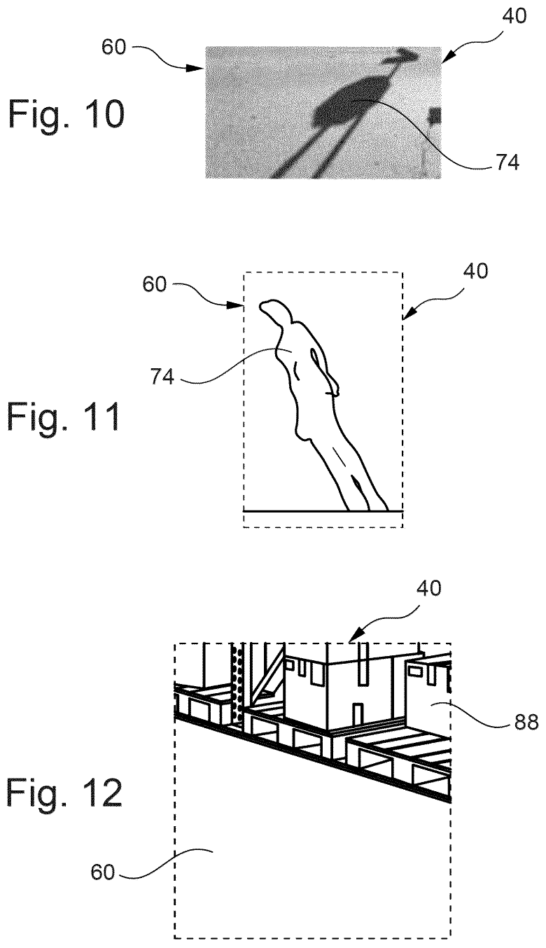

Shadows 74 are shown by way of example in FIGS. 10 and 11. In FIG. 10, shadows 74 of traffic signs can be seen on the ground area 60, thus shadows 74 of unmoving objects, which are to be compensated. In FIG. 11, a shadow 74 of a person passing by, thus a moving object, can be seen on the ground area 60. In this case, the compensation may not be carried out proceeding from the idea that the moving object will be expected to move out of the controlled area 46 soon.

A neural network is preferably used to learn and apply the compensating of the items of image information 54 or the items of reference image information 66 for the shadows 74. The training can be carried out for the items of reference image information 66 based on a plurality of training data, i.e. items of image information 54, which have been transmitted to the clearance server 14. The compensating can be generally trained, i.e. independently of a specific controlled area 46.

Step S180 relates to matching the items of image information 54 from the controlled area 46 with the items of reference image information 66 from the controlled area 46. For this purpose, a current vehicle position of the vehicle 12 is determined.

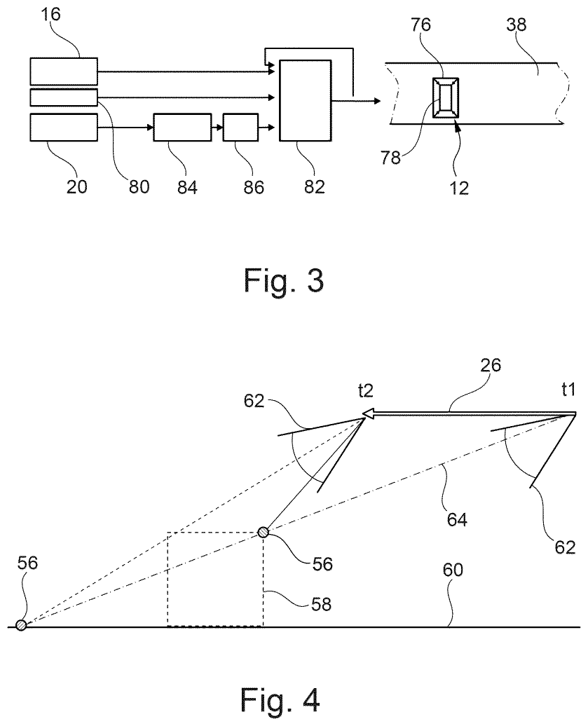

As is schematically shown in FIG. 3, the position of the vehicle 12 along the driving route 38 can be determined only with an accuracy indicated by an outer window 76. A more accurate determination of the position of the vehicle 12 is desirable, for example in the inner window 78.

The position of the vehicle 12 in the outer window 76 can be achieved, for example, using a position determination based on received satellite position signals of a global satellite navigation system, as is carried out using the assistance system 16 for autonomous parking of the vehicle 10.

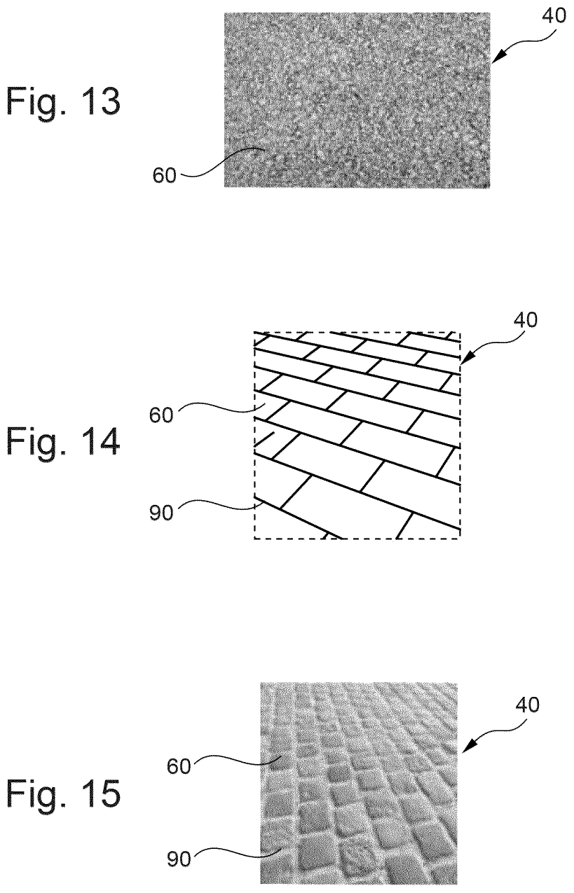

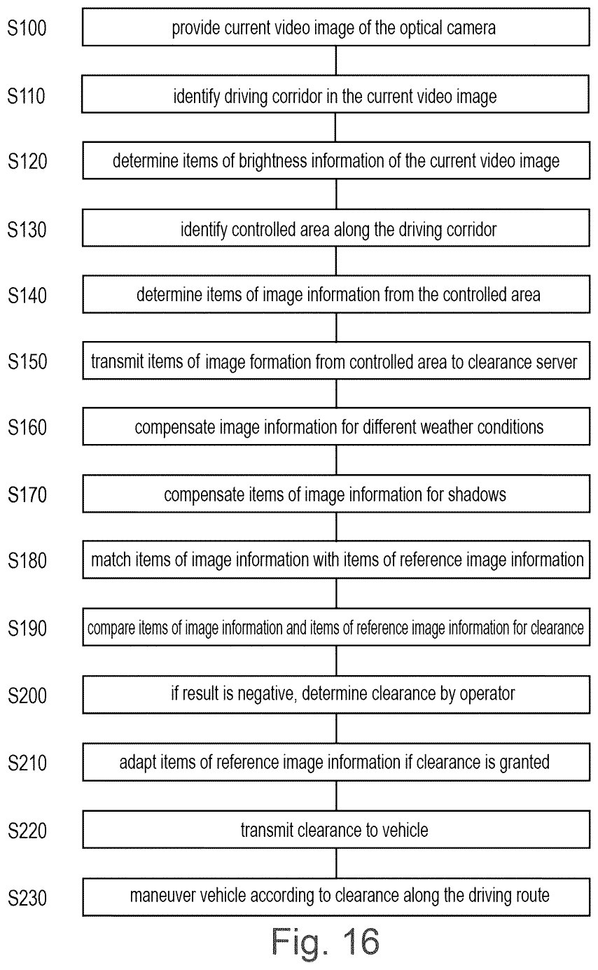

To improve the position determination, items of odometry information of the vehicle 12 are used, which are provided by wheel revolution sensors 80 on the wheels of the vehicle 12. In addition, items of visual odometry information of the vehicle 12 based on a ground structure can be used. Various ground structures are shown by way of example in FIGS. 12 to 15. Figure shows a ground area 60, as occurs, for example, in factory halls, as indicated on the basis of the pallets 88. The ground area from FIG. 12 is smooth and has no identifiable structure. This is typically not to be expected during the use of vehicles 12 in typical road traffic. FIG. 13 shows a ground area 60 having a coarse-pored ground structure, as can occur, for example, with asphalt or similar materials. FIG. 14 shows a ground area 60 having a uniform paving, which accordingly has uniform joints 90 in a two-dimensional arrangement. FIG. 15 also shows a ground area 60 having a paving, which has joints 90 in a two-dimensional arrangement. The pavings of FIGS. 14 and 15 are different, so that the joints 90 are arranged differently. Due to typical structures sizes of, for example, paving stones in the range of approximately 10 to 20 cm, high accuracies can be achieved in the position determination, for example, in the paving of FIGS. 14 and 15.

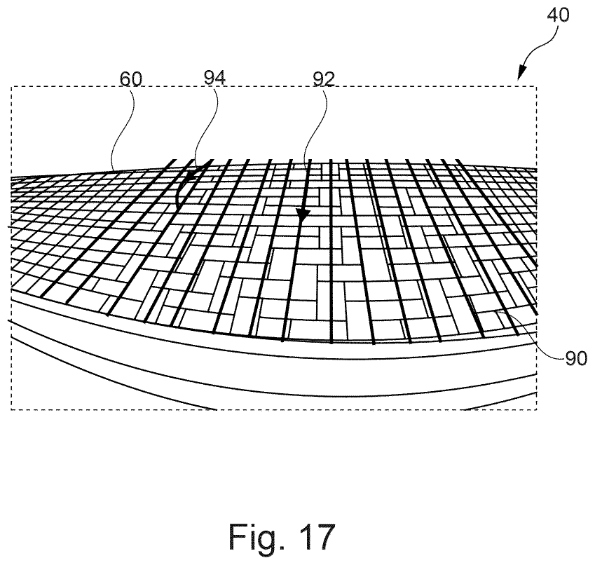

FIG. 17 additionally shows a pixel flow in the observation of ground structures. FIG. 17 shows a video image 40 having a ground area 60, which comprises a paving having joints 90. During driving in the direction of travel 26, individual features move in the level flowlines 92, i.e. the features approach the optical camera 20 in the arrow direction. Upon a disturbance, for example due to an obstacle, a deviating movement 94 results as indicated accordingly in FIG. 17.

The items of odometry information of the vehicle 12 are likewise transmitted to the cloud-based clearance server 14.

The cloud-based clearance server 14 additionally comprises a computing unit 82, which carries out a visual simultaneous position determination and mapping. The visual simultaneous position determination and mapping is known under the term “visual simultaneous localization and mapping” (V-SLAM) and is based on a position determination proceeding from images offset in time, due to which a position change of the vehicle 12 can be determined. For this purpose, the video images 40 are captured in an input data station 84 and filtered using a preliminary filter after the reception in the cloud-based clearance server 14. Subsequently, processing by the computing unit 82 takes place.

In addition, the computing unit 82 combines the items of position information of the position determination based on received satellite position signals of a global satellite navigation system and based on the items of odometry information of the vehicle 12 and the items of visual odometry information of the vehicle 12.

Step S190 relates to determining a clearance based on an automatic comparison of the received items of image information 54 from the controlled area 46 to items of reference image information 66 from the controlled area 46. The items of image information 54 and items of reference image information 66 relate to the same position, namely the currently observed controlled area 46. The items of reference image information 66 were determined preceding from a previously recorded comparison image and stored in the clearance server 14. Preferably, the items of reference image information 66 are based on multiple previously recorded comparison images, thus when the vehicle 12 or also another vehicle 12 has transmitted items of image information 54 for the corresponding controlled area 46 to the clearance server 14 and no obstacles were determined.

The items of reference image information 66 therefore contain items of image information 54 for which it has already been established that the vehicle 12 can drive into the driving corridor 42 in the direction toward the controlled area 46 and/or can drive into the controlled area 46. The items of reference image information 66 thus represent the controlled area 46 without obstacles. In the event of a deviation of the received items of image information 54 from the items of reference image information 66, a presence of an obstacle can be presumed. Otherwise, no obstacle is present. Differences between the items of image information 54 and the items of reference image information 66 thus have the result that no clearance is granted.

In this case, according to step S200, thus in the event of a negative clearance, a transmission of the received items of image information 54 from the controlled area 46 and the items of reference image information 66 from the controlled area 46 to an operator takes place, who determines a clearance. A manual clearance thus takes place.

If the clearance is granted in step S190, step S200 is skipped.

Step S210 relates to an adaptation of the items of reference image information 66 based on the received items of image information 54 upon a positive clearance by the operator. If the clearance is carried out by the operator, the items of reference image information 66 can thus be adapted so that in the observed controlled area 46, upon a renewed comparison of the same items of image information 54 and items of reference image information 66, the clearance can preferably already take place automatically. The adaptation of the items of reference image information 66 preferably takes place based on a machine learning process.

Step S210 can be carried out independently of step S200, i.e. even if the clearance based on the automatic comparison of the received items of image information 54 from the controlled area 46 to the items of reference image information 66 from the controlled area 46 takes place according to step S190, an adaptation of the items of reference image information 66 can be carried out based on the received items of image information 54.

Step S220 relates to a transmission of the clearance to move the vehicle 12 along the predetermined driving route 38 from the clearance server 14 to the vehicle 12. The clearance is transmitted via the data connection from the clearance server 14 to the vehicle 12. The transmission of the clearance represents a clearance for traveling through the observed controlled area 46.

Step S230 relates to a maneuvering of the vehicle 12 along the predetermined driving route 38 according to the received clearance. The maneuvering of the vehicle 12 along the predetermined driving route 38 is carried out according to the received clearance as autonomous driving of the vehicle 12. The vehicle 12 carries out a lateral and longitudinal control here to follow the predetermined driving route 38, due to which it initially drives in the direction toward the controlled area 46 and subsequently into the controlled area 46.

The cloud-based automatic maneuvering relates to an at least partially autonomous movement of the vehicle 12. The driving route 38 can be predetermined for this purpose, for example by a drive along the driving route 38 by a human vehicle driver, by which the driving route 38 can be learned. The predetermined driving route 38 connects the current vehicle position and the destination point. The predetermined driving route 38 indicates a route course for reaching the destination position.

By iteratively carrying out the method, a continuous check of the driving corridor 42 can take place, and the vehicle 12 can maneuver automatically along the driving corridor 42. Areas of the driving corridor 42 which are possibly located between the vehicle 12 and the controlled area 46 were already observed beforehand as the controlled area 46 and cleared.

In the case of current level 2 applications, for example, which require monitoring by the vehicle driver, the received clearance can replace a confirmation of the monitoring by the vehicle driver here.

Before the first performance of the method, the items of reference image information 66 have to be generated and stored in the storage means 36 of the cloud-based clearance server 14. This can take place in the context of a drive along the driving route 38 to learn the driving route 38, in particular as a trajectory. The trajectory comprises, in addition to the driving route 38, items of movement information for the maneuvering, for example speeds or accelerations. Based on the above-described method, video images 40 from the optical camera 20 are provided along the traveled driving route 38, and items of image information 54 from a respective controlled area 46 along a driving corridor 42 are stored as items of reference image information 66 from the controlled area 46 in the clearance server 14. A detail of the video images 40 can be transmitted as comparison images to the clearance server 14 as the items of image information 54. Driving along the driving route 38 and therefore learning the driving route 38 can be carried out using an arbitrary vehicle 12.

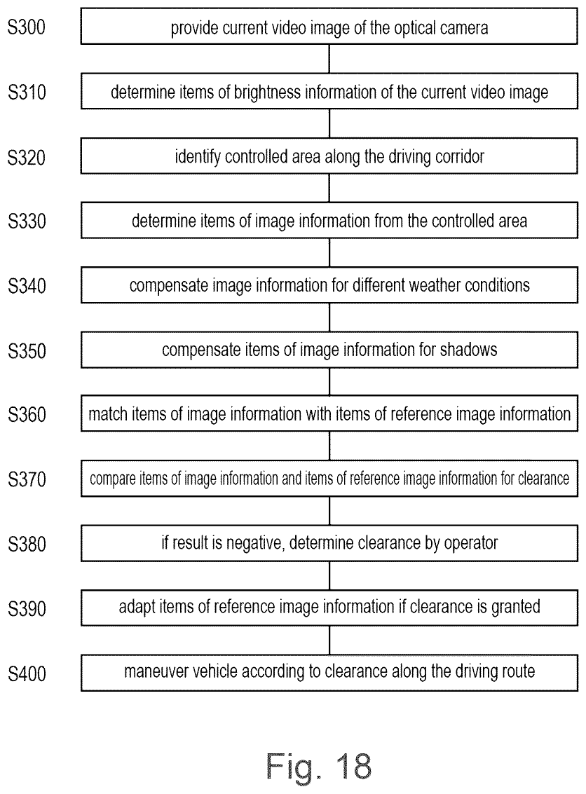

FIG. 18 relates to a second embodiment having a vehicle 12, which carries out a method shown in FIG. 18 for clearance-based automatic maneuvering of a vehicle 12 along a predetermined driving route 38 from a current vehicle position to a destination point. The method comprises a method for determining step-by-step clearances for automatically maneuvering the vehicle 12 along the predetermined driving route 38.

The method is carried out by a driver assistance system 10. The driver assistance system 10 is installed in the vehicle in this embodiment. Processing of items of image information 54 and the automatic comparison of the items of image information 54 to the items of reference image information 66 in the controlled area takes place locally in the driver assistance system 10. The items of reference image information 66 are stored in the vehicle 10.

The driver assistance system 10 of the second embodiment is not shown separately, but is similar to that of the first embodiment, because of which it is described hereinafter with reference to the first embodiment, wherein the description focuses on differences of the two driver assistance systems 10.

The driver assistance system 10 is installed in the vehicle 12 and comprises an assistance system 16 for autonomously parking the vehicle 10, in which a driving route 38 is predetermined or is determined beforehand, for example. The assistance system 16 comprises a control unit 18 which carries out the method. The assistance system 16 additionally comprises a sensor system 20, 22 having an optical camera 20 and a plurality of ultrasonic sensors 22, which are attached to the respective vehicle 12, for monitoring the surroundings 24 of the vehicle 12. The optical camera 20 is attached behind a windshield of the vehicle 12 to monitor the surroundings 24 in a direction of travel 26 in front of the vehicle 12. The control unit 18 and the sensor system 20, 22 are connected to one another via a data bus 28. The data bus 28 can be embodied, for example, according to a standard typical in the automotive sector such as CAN, LIN, LON, or FlexRay.

The driver assistance system 10 is designed to carry out the method described hereinafter for clearance-based automatic maneuvering of the vehicle 12 along the predetermined driving route 38 from a current vehicle position to a destination point. Such a driving route 38 is shown by way of example in FIG. 2.

The method begins in step S300 with providing a current video image 40 from the optical camera 20 at the current vehicle position. The above statements on the first embodiment having step S100 therein apply.

Step S310 relates to determining items of brightness information of the current video image 40 from the optical camera 20. Step S310 corresponds to above step S120 and is also optional here.

Step S320 relates to identifying a controlled area 46 along the driving corridor 42 depending on the driving route 38 and/or driving parameters of the vehicle 12. The above statements on corresponding step S130 of the first embodiment also apply here.

Step S330 relates to determining items of image information 54 from the controlled area 46 based on a flow of image elements 56, in particular pixels, based on at least two single video images 40 from the optical camera 20. Step S330 corresponds to corresponding step S140 of the first embodiment.

Step S340 relates to compensating the items of image information 54 from the controlled area 46 and/or items of reference image information 66 from the controlled area 46 for different weather conditions, in particular ground moisture, snow, or hail.

Step S350 relates to compensating the items of image information 54 from the controlled area 46 and/or the items of reference image information 66 from the controlled area 46 for shadows 74.

With respect to the compensating of steps S340 and S350, the above statements on step S160 and S170 apply accordingly.

Step S360 relates to matching the items of image information 54 from the controlled area 46 with the items of reference image information 66 from the controlled area 46. For this purpose, a current vehicle position of the vehicle 12 is determined. Reference is made to the above statements on step S180 therein.

Step S370 relates to determining a clearance based on an automatic comparison of the received items of image information 54 from the controlled area 46 to items of reference image information 66 from the controlled area 46. In this embodiment, the comparison is carried out by the control unit 18 in the vehicle 12. Moreover, the clearance is determined as described in corresponding step S190.

If no clearance is granted, in step S380, a transmission of the received items of image information 54 from the controlled area 46 and the items of reference image information 66 from the controlled area 46 to an operator takes place, who determines a clearance. A manual clearance thus takes place. In this embodiment, the items of image information 54 from the controlled area 46 and the items of reference image information 66 from the controlled area 46 are transmitted to a user interface of the vehicle 12 for an occupant of the vehicle 12 as the operator. The operator can check and grant the clearance via the user interface.

If the clearance is granted in step S370, step S380 is skipped.

Step S390 relates to an adaptation of the items of reference image information 66 based on the items of image information 54 upon a clearance by the operator. Here, in accordance with above step S210, the items of reference image information 66 stored in the vehicle are adapted so that in the observed controlled area 46, upon a renewed comparison of the same items of image information 54 and items of reference image information 66, the clearance can preferably already take place automatically. The adaptation of the items of reference image information 66 preferably also takes place here based on a machine learning process.

Step S390 can be carried out independently of step S380, i.e. even if the clearance based on the automatic comparison of the received items of image information 54 from the controlled area 46 to the items of reference image information 66 from the controlled area 46 takes place according to step S190, an additional adaptation of the items of reference image information 66 can be carried out based on the items of image information 54.

Step S400 relates to a maneuvering of the vehicle 12 along the predetermined driving route 38 according to the clearance. The statements above with respect to corresponding step S230 apply.

By iteratively carrying out the method, a continuous clearance can take place, and the vehicle 12 can maneuver automatically along the driving route 38. Areas in front of the vehicle 12 are each observed beforehand as controlled areas 46 and cleared.

Before the first performance of the method, the items of reference image information 66 have to be generated and stored in the vehicle 12. This can take place in the context of a drive along the driving route 38 to learn the driving route 38, in particular as a trajectory. The trajectory comprises, in addition to the driving route 38, items of movement information for the maneuvering, for example speeds or accelerations. Based on the above-described method, video images 40 from the optical camera 20 are provided along the traveled driving route 38, and items of image information 54 from a respective controlled area 46 along a driving corridor 42 are stored as items of reference image information 66 from the controlled area 46.

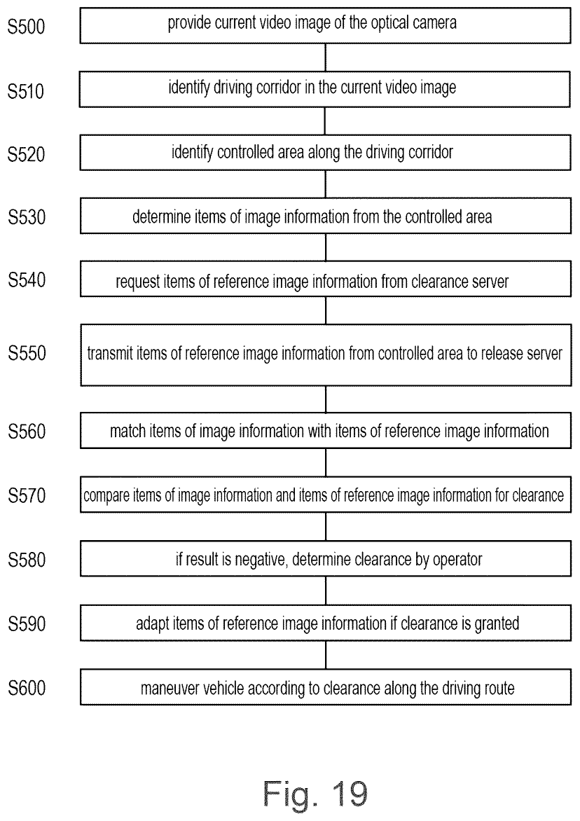

FIG. 19 relates to a third embodiment having a cloud-based driver assistance system 10, which carries out a method shown in FIG. 18 for clearance-based automatic maneuvering of a vehicle 12 along a predetermined driving route 38 from a current vehicle position to a destination point. The method comprises a method for determining step-by-step clearances for automatically maneuvering the vehicle 12 along the predetermined driving route 38.

The cloud-based driver assistance system 10 for carrying out the method of the third embodiment corresponds to that of the first embodiment, because of which more extensive statements in this regard are omitted.

The cloud-based driver assistance system 10 of the third embodiment is designed to carry out the method of the third embodiment described hereinafter for cloud-based automatic maneuvering of the vehicle 12 along the predetermined driving route 38 from a current vehicle position to a destination point. The method is based on a determination of step-by-step clearances for the vehicle 12 for automatically maneuvering along the predetermined driving route 38 and corresponds in large parts to the method of the first embodiment, because of which the description focuses on differences of the two methods.

The method of the third embodiment begins in step S500 with providing a current video image 40 from the optical camera 20 at the current vehicle position. The above statements on the first embodiment having step S100 therein apply.

Step S510 relates to identifying a driving corridor 42 in the current video image 40. The above statements on corresponding step S110 of the first embodiment apply.

Step S520 relates to identifying a controlled area 46 along the driving corridor 42 depending on the driving route 38 and/or driving parameters of the vehicle 12.

In this embodiment, the identification of the controlled area 46 takes place without consideration of items of brightness information from the current video image 40. Otherwise, the above statements on corresponding step S130 of the first embodiment apply.

Step S530 relates to determining items of image information 54 from the controlled area 46 based on a flow of image elements 56, in particular pixels, based on at least two single video images 40 from the optical camera 20. Step S530 corresponds to corresponding step S140 of the method of the first embodiment.

Step S540 relates to requesting the transmission of items of reference image information 66 from the controlled area 46 originating from a previously recorded comparison image from the cloud-based clearance server 14. A corresponding message is sent via the data connection by the assistance system 16 of the vehicle 12 via the communication unit 30 of the vehicle to the clearance server 14 with the request for the items of reference image information 66 for the controlled area 46. The requested items of reference image information 66 are stored in the cloud-based clearance server 14.

Step S550 relates to receiving the items of reference image information 66 from the controlled area 46 from the clearance server 14. According to the request in step S540, the items of reference image information 66 for the controlled area 46 of the previously recorded comparison image are transmitted from the cloud-based clearance server 14 to the vehicle 12.

For this purpose, the items of reference image information 66 from the controlled area 46 are compressed before the transmission by the cloud-based clearance server 14 and decompressed after the reception in the vehicle 12 by the control unit 18.

Step S560 relates to matching the items of image information 54 from the controlled area 46 with the items of reference image information 66 from the controlled area 46. For this purpose, a current vehicle position of the vehicle 12 is determined. Reference is made to the above statements on step S180 therein.

Step S570 relates to determining a clearance based on an automatic comparison of the items of image information 54 from the controlled area 46 to the received items of reference image information 66 from the controlled area 46. The items of image information 54 and items of reference image information 66 relate to the same position, namely the currently observed controlled area 46. In this embodiment, the comparison is carried out by the control unit 18 in the vehicle 12. Moreover, the clearance is determined as described in corresponding step S190.

If no clearance is granted, in step S580, a transmission of the received items of image information 54 from the controlled area 46 and the items of reference image information 66 from the controlled area 46 to an operator takes place, who determines a clearance. A manual clearance thus takes place. In this embodiment, the items of image information 54 from the controlled area 46 are transmitted via the data connection to the cloud-based clearance server 14 and are transmitted from there, together with the items of reference image information 66 from the controlled area 46, which are taken directly from the storage means 36, to a remotely connected operator who determines a clearance.

If the clearance is granted in step S570, step S580 is skipped.

Step S590 relates to an adaptation of the items of reference image information 66 based on the received items of image information 54 upon a positive clearance by the operator. The above statements on step S210 apply accordingly.

Step S590 can be carried out independently of step S580, i.e. even if the clearance based on the automatic comparison of the received items of image information 54 from the controlled area 46 to the items of reference image information 66 from the controlled area 46 already takes place according to step S190, an additional adaptation of the items of reference image information 66 can be carried out based on the items of image information 54, in that the respective items of image information 54 are transmitted to the cloud-based clearance server 14.

Step S600 relates to a maneuvering of the vehicle 12 along the predetermined driving route 38 according to the received clearance. The statements above with respect to corresponding step S230 apply.

Moreover, the statements with respect to the first embodiment for generating and storing the items of reference image information 66 in the storage means 36 of the cloud-based clearance server 14 also apply here.

### LIST OF REFERENCE SIGNS

10 cloud-based driver assistance system
12 vehicle
14 cloud-based clearance server
16 assistance system
18 control unit
20 optical camera, sensor system
22 ultrasonic sensor, sensor system
24 surroundings
26 direction of travel
28 data bus
30 communication unit
32 communication means
34 processing means
36 storage means
38 driving route
40 video image
42 driving corridor
44 boundary line
46 controlled area
48 distance limit
50 illuminated area
52 unilluminated area
54 items of image information
56 image element, pixel
58 box-shaped object
60 ground area
62 field of view
64 straight line
66 items of reference image information
68 damp underlying surface
70 dry underlying surface
72 puddle
74 shadow
76 outer window
78 inner window
80 wheel revolution sensor, odometry sensor
82 computing unit
84 input data station
86 preliminary filter
88 pallet
90 joint
92 level flowline
94 deviating movement

1. A method for determining step-by-step clearances for a vehicle for automatic maneuvering along a predetermined driving route from a current vehicle position to a destination point, wherein the vehicle comprises a sensor system having at least one optical camera for monitoring the surroundings in the direction of travel of the vehicle, comprising:
providing a current video image from the at least one optical camera at the current vehicle position;
determining a clearance for automatically maneuvering the vehicle along the predetermined driving route based on automatic comparison of items of image information from a controlled area of the video image to items of reference image information from the controlled area originating from a previously recorded comparison image; and
outputting the determined clearance for automatically maneuvering the vehicle along the predetermined driving route for a step which corresponds to the current video image.

2. The method as claimed in claim 1, comprising matching the items of image information from the controlled area with the items of reference image information from the controlled area.

3. The method as claimed in claim 2, wherein matching of the items of image information from the controlled area with the items of reference image information from the controlled area comprises a determination of a current vehicle position.

4. The method as claimed in claim 3, wherein
the determination of a current vehicle position comprises a determination of the current vehicle position based on a reception of signals from a satellite navigation system using a differential global positioning system, and/or
a provision of items of odometry information of the vehicle, and/or an identification of landmarks along the predetermined driving route of the vehicle, and/or
a determination of the current vehicle position using a system for visual simultaneous position determination and mapping.

5. The method as claimed in claim 4, wherein the provision of items of odometry information of the vehicle comprises a provision of items of visual odometry information of the vehicle based on a ground structure and/or a provision of sensor signals from at least one odometry sensor of the vehicle.

6. The method as claimed in claim 1 wherein when clearance is absent, the method comprises transmitting the items of image information from the controlled area and the items of reference image information from the controlled area to an operator to determine the clearance.

7. The method as claimed in claim 6, wherein the method comprises adapting the items of reference image information based on the items of image information from the controlled area upon a clearance by the operator.

8. The method as claimed in claim 1 comprising:
driving along the driving route to learn the driving route as a trajectory, comprising:
providing video images from the at least one optical camera along the traveled driving route, and
storing items of image information from the controlled area as items of reference image information from the controlled area or at least a detail of the video images as comparison images.

9. The method as claimed in claim 8, comprising transmitting the items of image information from the controlled area as items of reference image information from the controlled area or at least a detail of the video images as comparison images to a cloud-based clearance server.

10. The method as claimed in claim 1 comprising determining the items of image information from the controlled area based on a flow of pixels based on at least two single video images from the at least one optical camera.

11. The method as claimed in claim 1 comprising:
identifying a driving corridor in the current video image; and identifying the controlled area along the driving corridor depending on the driving route and/or driving parameters of the vehicle.

12. The method as claimed in claim 1 wherein the method comprises:
determining items of brightness information of the current video image from the at least one optical camera, wherein an identification of the controlled area takes place with consideration of the determined items of brightness information of the current video image, and/or
determining the items of image information from the controlled area in consideration of determined items of brightness information of the current video image.

13. The method as claimed in claim 1 comprising compensating the items of image information from the controlled area and/or items of reference image information from the controlled area for ground moisture, snow, or hail.

14. The method as claimed in claim 1 comprising compensating the items of image information from the controlled area and/or the items of reference image information from the controlled area for shadows.

15. The method as claimed in claim 14, wherein the compensation of the items of image information from the controlled area and/or the items of reference image information from the controlled area for shadows comprises a time-dependent compensation of the items of image information from the controlled area and/or the items of reference image information from the controlled area for shadows.

16. The method as claimed in claim 1 comprising:
transmitting the items of image information from the controlled area to a cloud-based clearance server; and
transmitting the determined clearance to move the vehicle along the predetermined driving route from the cloud-based clearance server to the vehicle,
wherein the previously recorded comparison image is stored in the cloud-based clearance server and the determination of the clearance comprises a determination of the clearance in the cloud-based clearance server.

17. The method as claimed in claim 16, comprising:
compressing the items of image information from the controlled area before the transmission of the items of image information to the cloud-based clearance server; and
decompressing the transmitted items of image information from the controlled area after the transmission of the items of image information to the cloud-based clearance server.

18. The method as claimed in claim 1 wherein the items of reference image information are stored in a cloud-based clearance server, and the method comprises receiving the items of reference image information from the controlled area originating from the previously recorded comparison image from the cloud-based clearance server, wherein the determination of the clearance comprises a determination of the clearance in the vehicle.

19. The method as claimed in claim 18, comprising requesting the transmission of the items of reference image information from the controlled area originating from the previously recorded comparison image from the cloud-based clearance server.

20. The method as claimed in claim 18, comprising:
compressing the items of reference image information from the controlled area before the transmission of the items of reference image information to the cloud-based clearance server; and
decompressing the received items of reference image information from the controlled area after the reception of the items of reference image information from the cloud-based clearance server.

21. A method for clearance-based automatic maneuvering of a vehicle along a predetermined driving route from a current vehicle position to a destination point, wherein the vehicle comprises a sensor system having at least one optical camera for monitoring the surroundings in the direction of travel of the vehicle, wherein the method comprises determining step-by-step clearances for automatic maneuvering of the vehicle along the predetermined driving route using the method as claimed in claim 1.

22. The method as claimed in claim 21, wherein the method for clearance-based automatic maneuvering of the vehicle is carried out based on a control of the vehicle by an external server, a control of the vehicle based on a method for visual automatic localization and mapping, V-SLAM, or a control of the vehicle based on a method for automatic localization and mapping using at least one surroundings sensor to generate a point cloud of the surroundings of the vehicle using at least one radar sensor and/or one LiDAR-based surroundings sensor.

23. The method as claimed in claim 21, wherein the method for clearance-based automatic maneuvering of a vehicle along a predetermined driving route from a current vehicle position to a destination point is carried out for automatic valet parking or for trained parking using a previously learned trajectory for driving along the driving route.

24. The method as claimed in claim 21, wherein the method comprises a reception of a position of the vehicle based on the reception of signals of a global satellite navigation system, GNSS, and the method comprises a selection of a driving route based on the received position of the vehicle.

25. A driver assistance system for a vehicle, wherein the driver assistance system is designed to carry out the method as claimed in claim 1.

26. A cloud-based driver assistance system having at least one vehicle and a cloud-based clearance server, wherein the at least one vehicle and the cloud-based clearance server are connected to one another via a data connection, and the cloud-based driver assistance system is designed to carry out the method as claimed in claim 1.
